(19) United States
(12) Patent Application Publication
(10) Pub. No.: US 2025/0251029 A1
(43) Pub. Date: Aug. 7, 2025

(54) TORQUE-DRIVE ACTIVE CONTROL SYSTEM BASED ON PRINCIPLE OF ROTATION

(71) Applicant: SHENYANG UNIVERSITY OF TECHNOLOGY, Shenyang (CN)

(72) Inventor: Chunwei ZHANG, Shenyang (CN)

(21) Appl. No.: 19/051,423

(22) Filed: Feb. 12, 2025

Related U.S. Application Data
(63) Continuation of application No. PCT/CN2023/083785, filed on Mar. 24, 2023.

(30) Foreign Application Priority Data
Aug. 15, 2022 (CN) 202210973820.3

(51) Int. Cl. F16F 7/10

(52) U.S. Cl. CPC F16F 7/1005; F16F 2222/08; F16F 2230/18; F16F 2236/08

(57) ABSTRACT

A torque-drive active control system based on principle of rotation includes a first motor, a first rotating shaft, a rotating assembly, a sensor and a controller. The first motor is arranged on a to-be-controlled object. The first rotating shaft is rotatably arranged on the to-be-controlled object. The rotating assembly is arranged on the first rotating shaft. The first motor is drivably connected with the first rotating shaft. The sensor is configured to monitor a torsional angle of the to-be-controlled object, and the controller is configured to process the torsional angle and output instructions to control the first motor to drive the first rotating shaft, so that the first rotating shaft drives the rotating assembly to rotate to generate a torque. The torque is transmitted to the to-be-controlled object through the first rotating shaft to offset the torsional vibration of the to-be-controlled object.

### CROSS-REFERENCE TO RELATED APPLICATIONS

This application is a continuation of International Patent Application No. PCT/CN2023/083785, filed on Mar. 24, 2023, which claims the benefit of priority from Chinese Patent Application No. 202210973820.3, filed on Aug. 15, 2022. The content of the aforementioned application, including any intervening amendments thereto, is incorporated herein by reference in its entirety.

### TECHNICAL FIELD

This application relates to bridge engineering, and more particularly to a torque-drive active control system based on principle of rotation.

### BACKGROUND

The train will experience strong vibration while traveling on an uneven bridge track, and the vibration generated by the train will further cause deformation of the track.

The vibration will become more intense as the track's deformation becomes more serious, which indirectly aggravates the effect of the train's vibration on the bridge, and will even lead to the bridge collapse.

Vibration control of the bridge usually adopts a passive control strategy such as using a damper. However, the damper can only output a linear control force, that is, the damper can only control horizontal vibration and vertical vibration generated by the bridge, but cannot control torsional vibration generated by the bridge. Besides, the damper also has the following defects. (1) The damper has a limited tensile strength, and is prone to fracture when there is a sympathetic vibration between the train and the bridge. (2) When the damper controls the bridge vibration, the internal damping fluid is prone to emulsification at high temperature under the action of high-frequency reciprocating motion, making the control performance unstable. Moreover, because of the coupling effect between displacement and swing angle, the tuned mass damper cannot be used for the control of vibration involving rotation characteristics, therefore, it often fails to effectively control the torsional vibration of the bridge. (3) The linear control force of the damper will cause chaos phenomenon when the damper controls the torsional vibration of the bridge. The damper has different control effects under different excitation frequencies, however, under a certain excitation frequency, the tuned mass damper has no control effect on the bridge vibration, and may even aggravate the vibration, failing to reach the expected effect.

### SUMMARY

This application provides a torque-drive active control system based on principle of rotation to solve the problem in the prior art that the bridge stability is poor since the existing dampers cannot effectively control the torsional vibration of the bridge.

Technical solutions of this application are described as follows.

A torque-drive active control system based on principle of rotation is provided, comprising:
a first motor;
a first rotating shaft;
a rotating assembly;
a sensor; and
a controller;
wherein the first motor is configured to be arranged on a to-be-controlled object; the first rotating shaft is rotatably arranged on the to-be-controlled object; the rotating assembly is arranged on an end of the first rotating shaft away from the to-be-controlled object; the first motor is drivably connected with the first rotating shaft; the controller is connected with the sensor, and is also connected with the first motor; the sensor is configured to detect a torsion angle of the to-be-controlled object and transmit the torsion angle to the controller; and the controller is configured to process the torsion angle to obtain a processing result, and output a control instruction to the first motor according to the processing result to control the first motor to drive the first rotating shaft to rotate, so that the first rotating shaft drives the rotating assembly to rotate.

In an embodiment, the torque-drive active control system further comprises a first transmission assembly; and the first motor is drivably connected with the first rotating shaft through the first transmission assembly.

In an embodiment, the first transmission assembly comprises a first gear and a second gear; the first gear is sleevedly provided on the first rotating shaft; the first motor comprises a second rotating shaft; the second gear is sleevedly provided on the second rotating shaft; and the first gear is engaged with the second gear for transmission.

In an embodiment, a plurality of first motors and a plurality of second gears are provided; the plurality of first motors are arranged on the to-be-controlled object; the plurality of second gears are arranged on the plurality of first motors in one-to-one correspondence; and the plurality of second gears are respectively engaged with the first gear for transmission.

In an embodiment, the rotating assembly comprises a rotating component, a second motor, a second rotating shaft and a rotary plate; the rotating component is arranged on the end of the first rotating shaft away from the to-be-controlled object; the second motor is arranged a side of the rotating component away from the first rotating shaft, and the second rotating shaft is rotatably arranged on the side of the rotating component away from the first rotating shaft; the rotary plate is arranged on an end of the second rotating shaft away from the rotating component; the second motor is drivably connected with the rotary plate; and the controller is configured to control the second motor to drive the rotary plate to rotate according to the processing result.

In an embodiment, the rotating component comprises a rotating base and a rotating arm arranged on the rotating base; the rotating base is arranged on the end of the first rotating shaft away from the to-be-controlled object; the second motor is arranged on a side of the rotating arm away from the first rotating shaft; and the second rotating shaft is rotatably arranged on a side of the rotating base away from the first rotating shaft.

In an embodiment, the number of the rotating arm is plurality, and the number of the second motor is plurality; the plurality of rotating arms are arranged on the rotating base spaced apart each other; the plurality of second motors are arranged on sides of the plurality of rotating arms away from the first rotating shaft in one-to-one correspondence; and each one of the plurality of second motors is drivably connected with the rotary plate.

In an embodiment, the torque-drive active control system further comprises a base assembly; the base assembly is configured to be installed in the to-be-controlled object; the first motor is arranged on the base assembly; and the first rotating shaft is rotatably arranged on the base assembly.

In an embodiment, the base assembly comprises a mounting base and a connecting arm arranged on the mounting base; an end of the connecting arm away from the mounting base is connected with an inner wall of the to-be-controlled object; the first motor is arranged on the mounting base; and the first rotating shaft is rotatably arranged on the mounting base.

In an embodiment, a plurality of connecting arms are provided; the plurality of connecting arms are arranged spaced apart on the mounting base; and an end of each one of the plurality of connecting arms away from the mounting base is connected with the inner wall of the to-be-controlled object.

Compared to the prior art, this application has the following beneficial effects.

The first rotating shaft is arranged on the to-be-controlled object. The sensor detects the torsion angle, and transmits the torsion angle to the controller, and then the controller processes the torsion angle to obtain a processing result, and outputs a corresponding control instruction to the first motor according to the processing result to control the first motor to drive the first rotating shaft to rotate, so that the first rotating shaft drives the rotating assembly to rotate, such that the rotating assembly can generate a torque to offset torsional vibration of the to-be-controlled object. The torque generated by the rotating assembly is transmitted to the object to be controller through the first rotating shaft, so as to offset the torsional vibration of the to-be-controlled object, which improves the stability of the to-be-controlled object.

### BRIEF DESCRIPTION OF THE DRAWINGS

In order to illustrate the technical solutions of this application or the prior art more clearly, the accompanying drawings required in the description of embodiments or the prior art will be briefly introduced below. It is obvious that the following accompanying drawings only show some embodiments of this application, and for those of ordinary skill in the art, other relevant accompanying drawings can also be obtained according to these drawings without making creative effort.

FIG. 1 is a schematic diagram of a torque-drive active control system based on principle of rotation according to an embodiment of the present disclosure.

FIG. 2 is a partial sectional view of the torque-drive active control system based on principle of rotation according to an embodiment of the present disclosure.

FIG. 3 is a partial schematic diagram of the torque-drive active control system based on principle of rotation according to an embodiment of the present disclosure.

In Figures: 100, torque-drive active control system; 1, first motor; 011, second rotating shaft; 2, first rotating shaft; 3, rotating assembly; 31, rotating component; 311, rotating base; 312, rotating arm; 32, second motor; 321, fourth rotating shaft; 33, third rotating shaft; 34, rotary plate; 4, sensor; 5, controller; 6, to-be-controlled object; 7, first transmission assembly; 71, first gear; 72, second gear; 8, first bearing; 9, second bearing; 10, connecting component; 11, second transmission assembly; 111, third gear; 12, base assembly; 121, mounting base; 122, connecting arm; 13, first fixing component; and 14, second fixing component.

### DETAILED DESCRIPTION OF EMBODIMENTS

The technical solutions of the embodiments of the present disclosure will be clearly and completely described with reference to the accompanying drawings of the embodiments of the present disclosure. It is obvious that described herein are only some embodiments of the present disclosure, rather than all embodiments. Based on the embodiments of the present disclosure, other embodiments obtained by those of ordinary skill in the art without making creative effort shall fall within the scope of the present disclosure.

It should be noted that the terms, such as “up”, “down”, “left”, “right”, “front”, “rear” and other directional indications used herein, are only used for illustrating relative position relationship and motion between components in a specific state (as shown in the accompanying drawings). If the specific state changes, the directional indication accordingly changes.

In addition, the terms “first” and “second” are only used for distinguishment rather than indicating or implying the relative importance or implicitly specifying the number of technical features indicated. Therefore, a feature defined with “first” or “second” may explicitly or implicitly indicates the inclusion of at least one of such features. Besides, the term “and/or” used herein includes three solutions, for example, “A” and/or “B” includes solution “A”, solution “B”, and a combination thereof. Technical solutions of embodiments can be combined with each other as long as the combined solution can be implemented by those skilled in the art. When a combination of the technical solutions is contradictory or cannot be realized, it should be considered that such a combination does not exist, and is not within the scope of the present disclosure.

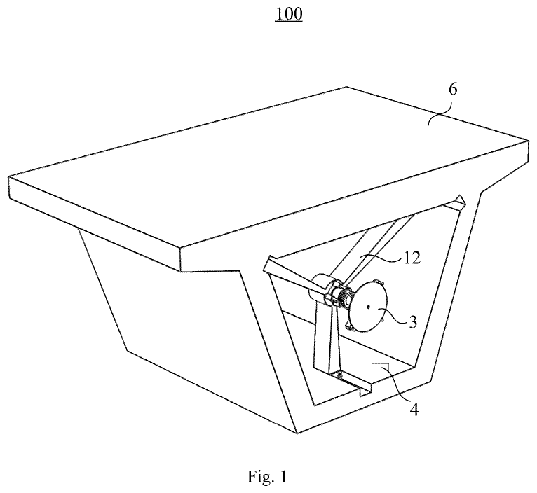

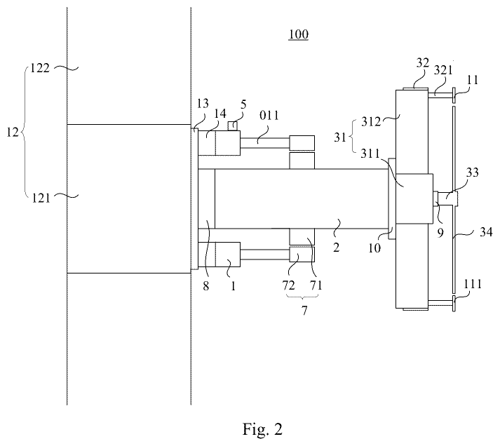

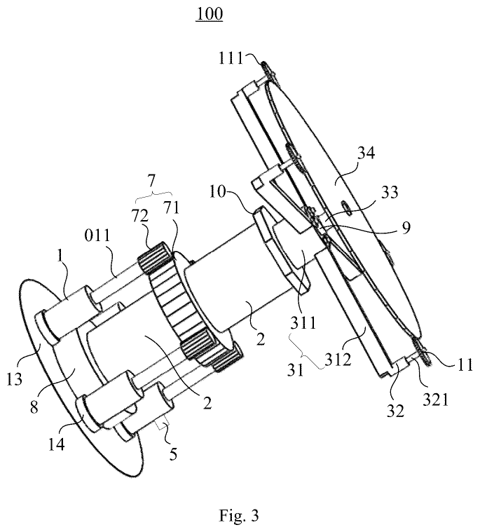

Referring to FIGS. 1-3, the present disclosure provides a torque-drive active control system 100 based on principle of rotation, including a first motor 1, a first rotating shaft 2, a rotating assembly 3, a sensor 4 and a controller 5. The first motor 1 is configured to be arranged on a to-be-controlled object 6. The first rotating shaft 2 is rotatably arranged on the to-be-controlled object 6. The rotating assembly 3 is arranged on an end of the first rotating shaft 2 away from the to-be-controlled object 6. The first motor 1 is drivably connected with the first rotating shaft 2. The controller 5 is connected with the sensor 4, and is also connected with the first motor 1. The sensor 4 is configured to detect a torsion angle of the to-be-controlled object 6 and transmit the torsion angle to the controller 5. The controller 5 is configured to process the torsion angle to obtain a processing result, and output a control instruction to the first motor 1 according to the processing result to control the first motor to drive the first rotating shaft 2 to rotate, so that the first rotating shaft 2 drives the rotating assembly 3 to rotate.

The first rotating shaft 2 is arranged on the to-be-controlled object 6. The sensor 4 detects the torsion angle, and transmits the torsion angle to the controller 6, and then the controller 5 processes the torsion angle to obtain a processing result, and outputs a control instruction to the first motor 1 according to the processing result to control the first motor 1 to drive the first rotating shaft 2 to rotate, so that the first rotating shaft 2 drives the rotating assembly 3 to rotate, such that the rotating assembly 3 can generate a torque to offset torsional vibration of the to-be-controlled object 6. The torque generated by the rotating assembly 3 is transmitted to the object to be controller 6 through the first rotating shaft, so as to offset the torsional vibration of the to-be-controlled object 6, which improves the stability of the to-be-controlled object 6.

In this embodiment, the principle of rotation refers to that the rotating assembly 3 can generate a torque in an opposite direction of a torsional direction of the to-be-controlled object 6, so as to offset the torque of the torsional vibration of the to-be-controlled object 6. With the cooperation of the sensor 4 and controller 5, the torque generated by the rotating assembly 3 can be adjusted in real time, so as to offset the torque of the torsional vibration of the to-be-controlled object 6 in real time.

In this embodiment, the to-be-controlled object is a bridge.

In this embodiment, the first motor 1 is a torque motor, which can generate a relatively large torque, so that the rotating assembly 3 can quickly generate the torque to offset the torsional vibration of the to-be-controlled object 6.

In this embodiment, the sensor 4 is arranged on the to-be-controlled object, and the controller 5 is arranged on the first motor 1.

In an embodiment, the torque-drive active control system 100 further includes a first transmission assembly 7. The first motor 1 is drivably connected with the first rotating shaft 2 through the first transmission assembly 7. When the first transmission assembly 7 is damaged, it is only to replace the damaged first transmission assembly 7 without replacing the first motor 1 and/or the first transmission assembly 7, so as to reduce a replacement cost of the torque-drive active control system 100.

In an embodiment, the first transmission assembly 7 includes a first gear 71 and a second gear 72. The first gear 71 is sleevedly provided on the first rotating shaft 2. The first motor 1 includes a second rotating shaft 011. The second gear 72 is sleevedly provided on the second rotating shaft 011. The first gear 71 is engaged with the second gear 72 for transmission. The first motor 1 drives the second rotating shaft 011 to rotate, the second rotating shaft 011 drives the second gear 72 to rotate, the second gear 72 drives the first gear 71 to rotate, and the first gear 71 drives the first rotating shaft 2 to rotate, so that the first rotating shaft 2 drives the rotating assembly 3 to rotate. The first transmission assembly 7 is set that the first gear 71 is engaged with the second gear 72 for transmission, so that the first transmission assembly 7 has a simple structure and a low cost. In addition, the first gear 71 and the second gear 72 have high driving efficiency, so that the first motor 1 accelerates the first rotating shaft 2 to rotate.

In an embodiment, a plurality of first motors and a plurality of second gears 72 are provided. The plurality of first motors 1 are arranged on the to-be-controlled object 6. The plurality of second gears 72 are arranged on the plurality of first motors 1 in one-to-one correspondence. The plurality of second gears 72 are engaged with the first gear 71 for transmission. With the cooperation of the first gear 71 and the plurality of second gears 72, the first rotating shaft 2 is accelerated to rotate, so that the first rotating shaft 2 can drives the rotating assembly 3 to quickly generate the torque to offset the torsional vibration of the to-be-controlled object 6.

In an embodiment, the plurality of first motors 1 are evenly arranged around the first rotating shaft 2.

In an embodiment, the number of the first motor 1 is four, and the number of the second gear 72 is four.

In an embodiment, the torque-drive active control system 100 further includes a first bearing 8. The first bearing is arranged on the to-be-controlled object 6. The first rotating shaft is connected with the first bearing 8, so that the first rotating shaft 2 is rotatably arranged on the to-be-controlled object 6.

In an embodiment, the rotating assembly 3 includes a rotating component 31, a second motor 32, a third rotating shaft 33 and a rotary plate 34. The rotating component 31 is arranged on the end of the first rotating shaft 2 away from the to-be-controlled object 6. The second motor 32 is arranged a side of the rotating component 31 away from the first rotating shaft 2, and the third rotating shaft 33 is rotatably arranged on the side of the rotating component 31 away from the first rotating shaft 2. The rotary plate 34 is arranged on an end of the third rotating shaft 33 away from the rotating component 31. The second motor 32 is drivably connected with the rotary plate 34. The controller 5 is configured to control the second motor 32 to drive the rotary plate 34 to rotate according to the processing result. The second motor 32 drives the rotary plate 34 to rotate through the controller 5, which can accelerate rotation of the rotary plate 34, so that the rotary plate 34 can quickly generate the torque to offset the torsional vibration of the to-be-controlled object 6, improving control effects and control efficiency of the torque-drive active control system 100.

In an embodiment, the rotating component 31 includes a rotating base 311 and a rotating arm 312 arranged on the rotating base 311. The rotating base 311 is arranged on the end of the first rotating shaft 2 away from the to-be-controlled object 6. The second motor 32 is arranged on a side of the rotating arm 312 away from the first rotating shaft 2. The third 33 is rotatably arranged on a side of the rotating base 311 away from the first rotating shaft 2.

In an embodiment, a plurality of rotating arms 312 and a plurality of second motors 32 are provided. The plurality of rotating arms 312 are arranged on the rotating base 311 spaced apart each other. The plurality of second motors 32 are arranged on sides of the plurality of rotating arms 312 away from the first rotating shaft 2 in one-to-one correspondence. Each one of the plurality of second motors 32 is drivably connected with the rotary plate 34. The plurality of second motors 32 can drive corresponding third rotating shaft 33, so that the third rotating shaft 33 can drive the rotary plate 34 to quickly generate the torque to offset the torsional vibration of the to-be-controlled object 6, which further improves real-time performance of the torque generated by the torque-drive active control system 100.

In an embodiment, the number of the rotating arm 312 is four, and the number of the second motor 32 is four.

In an embodiment, the torque-drive active control system 100 further includes a second bearing 9. The second bearing 9 is arranged on the side of the rotating base 311 away from the first rotating shaft 2. The third rotating shaft 33 is connected with the second bearing 9, so that the third rotating shaft 33 is rotatably arranged on the side of the rotating base 311 away from the first rotating shaft 2.

In an embodiment, the torque-drive active control system 100 further includes a connecting component 10. The rotating component 31 is connected with the end of the first rotating shaft 2 away from the to-be-controlled object 6 through the connecting component 10. The connecting component 10 can improve reliability of the connection between the rotating component 31 and the end of the first rotating shaft 2 away from the to-be-controlled object 6.

In this embodiment, the second motor 32 is a high-speed motor, which has a relatively high rotating speed. It can be understood that the high-speed motor refers to a motor with a rotating speed over 10000 r/min.

In this embodiment, the rotary plate 34 is round, square, or oval.

In an embodiment, the torque-drive active control system 100 further includes a second transmission assembly 11. The second motor 32 is in drivably connected with the rotary plate 34 through the second transmission assembly 11.

In an embodiment, the transmission assembly includes a third gear 111. The second motor comprises a fourth rotating shaft 321. The third gear 111 is sleevedly arranged on the fourth rotating shaft 321. An outer wall of the rotary plate 34 is provided with a ring of gear teeth, and the third gear 111 is engaged with the rotary plate 34 for transmission.

In an embodiment, a plurality of third gears 111 are provided. The plurality of third gears 111 are arranged on a plurality of fourth rotating shaft 321 of the plurality of second motors 32. Each one of the plurality of third gears 111 is engaged with the rotary plate 34 for transmission.

In an embodiment, the number of the third gear 111 is four.

In an embodiment, the torque-drive active control system 100 further includes a base assembly 12. The base assembly 12 is configured to be installed in the to-be-controlled object 6. The first motor 1 is arranged on the base assembly 12. The first rotating shaft 2 is rotatably provided on the base assembly 12. The base assembly 12 is installed in the to-be-controlled object 6, so that the torque generated by the rotating assembly 3 can successively pass through the first rotating shaft 2 and the base assembly 12 and be transferred to the to-be-controlled object, so that the torque generated by the rotary plate 34 can better offset the torsional vibration of the to-be-controlled object 6, so as to improve the stationarity of the to-be-controlled object 6.

In an embodiment, the base assembly 12 includes a mounting base 121 and a connecting arm 122 arranged on the mounting base 121. An end of the connecting arm 122 away from the mounting base 121 is connected with an inner wall of the to-be-controlled object 6. The first motor 1 is arranged on the mounting base 121. The first rotating shaft 2 is rotatably arranged on the mounting base 121.

In this embodiment, the connecting arm 122 has a flat bar structure. Compared with a plate-shaped connecting arm with a larger area, such setting can reduce cost and weight of the torque-drive active control system 100, so as to reduce a load of the torque-drive active control system 100 to the to-be-controlled object, which further improves security of the to-be-controlled object.

In an embodiment, the number of the connecting arm 122 is plurality. The plurality of connecting arms 122 are arranged on the mounting base 121 spaced apart each other. An end of each of the plurality of connecting arms 122 away from the mounting base 121 is connected with the inner wall of the to-be-controlled object 6. The plurality of connecting arms 122 can not only improve the connection reliability between the mounting base 121 and the to-be-controlled object, but also transmit the torque generated by the rotating assembly 3 to different parts of the to-be-controlled object, respectively, so that the torque generated by the rotating assembly 3 can better offset the torsional vibration of the to-be-controlled object 6, so as to improve the stationarity of the to-be-controlled object 6.

In an embodiment, the number of the connecting arm 122 is three.

In an embodiment, the torque-drive active control system 100 further includes a first fixing component 13. The first fixing component 13 is removably provided on the base assembly 12. The first motor is arranged on an end of the first fixing component 13 away from the base assembly 12. The first rotating shaft 2 is rotatably arranged on the end of the first fixing component 13 away from the base assembly 12. By assembling and disassembling the first fixing component 13, the first motor 1 and the first rotating shaft 2 can be assembled on the base assembly 12 or be disassembled from the base assembly 12, so as to improve assembling and disassembling efficiency of the torque-drive active control system 100.

In an embodiment, the first bearing 8 is arranged on a side of the first fixing component 13 away from the base assembly 12. The first rotating shaft 2 is connected with the first bearing.

In an embodiment, the torque-drive active control system 100 further includes a second fixing component 14. The second fixing component is arranged on the first fixing component 13. The first motor 1 is arranged on a side of the second fixing component 14 away from the first fixing component 13.

A working principle of the torque-drive active control system 100 is described as follows.

When the torsional vibration occurs on the to-be-controlled object 6. The sensor 4 monitors the torsional angle of the to-be-controlled object 6, and sends the torsional angle to the controller 5. The controller 5 receives the torsional angle from the sensor 4, and processes the torsional angle through built-in algorithm, and then obtain the processing result. The controller 5 outputs the control instruction to the first motor 1 and the second motor 32 to rotate according to the processing result. The first motor 1 drives the first rotating shaft 2 to rotate, so that the first rotating shaft 2 drives the rotating component 31 to generate a rotational motion. The second motor 32 drives the fourth rotating shaft 321 to generate a rotational motion, so that the fourth rotating shaft 321 drives the second transmission assembly 11 to generate a rotational motion. In this way, the second transmission assembly 11 drives the rotary plate 34 to accelerate to rotate to improve the control effect and the control efficiency, so that the rotating component 31 the rotary plate 34 together generate the torque in the opposite direction of the torsional direction of the to-be-controlled object 6, where the torque generated by the rotary plate 34 successively passes through the third rotating shaft 33, the rotating component 31 and the first rotating shaft 2 and finally is transmitted the to-be-controlled object. The torque generated by the rotating component 31 was transmitted through the first rotating shaft 2 to the to-be-controlled object, to offset the torsional vibration of the to-be-controlled object 6, so as to improve the stationarity of the to-be-controlled object 6.

Described above are only preferred embodiments of the present disclosure, which are not intended to limit the disclosure. Though the present disclosure has been described in detail above, those skilled in the art can still make various modifications, changes and replacements to the features recited herein. It should be understood that those modifications, changes and replacements without departing from the spirit of the disclosure shall fall within the scope of this application defined by the appended claims.

What is claimed is:

1. A torque-drive active control system based on principle of rotation, comprising:
a first motor;
a first rotating shaft;
a rotating assembly;
a sensor;
a controller; and
a base assembly;
wherein the first motor is configured to be arranged on a to-be-controlled object; the first rotating shaft is rotatably arranged on the to-be-controlled object; the rotating assembly is arranged on an end of the first rotating shaft away from the to-be-controlled object; the first motor is drivably connected with the first rotating shaft; the controller is connected with the sensor and the first motor; and the sensor is configured to detect a torsion angle of the to-be-controlled object and transmit the torsion angle to the controller;
the controller is configured to process the torsion angle to obtain a processing result, and output a control instruction to the first motor according to the processing result to control the first motor to drive the first rotating shaft to rotate, so that the first rotating shaft drives the rotating assembly to rotate; and
the base assembly is configured to be installed in the to-be-controlled object; the base assembly comprises a mounting base and a connecting arm arranged on the mounting base; an end of the connecting arm away from the mounting base is connected with an inner wall of the to-be-controlled object; the first motor is arranged on the mounting base; and the first rotating shaft is rotatably arranged on the mounting base.

2. The torque-drive active control system of claim 1, further comprising:
a first transmission assembly;
wherein the first motor is drivably connected with the first rotating shaft through the first transmission assembly.

3. The torque-drive active control system of claim 2, wherein the first transmission assembly comprises a first gear and a second gear; the first gear is sleevedly provided on the first rotating shaft; the first motor comprises a second rotating shaft; the second gear is sleevedly provided on the second rotating shaft; and the first gear is engaged with the second gear for transmission.

4. The torque-drive active control system of claim 3, wherein a plurality of first motors and a plurality of second gears are provided; the plurality of first motors are arranged on the to-be-controlled object; the plurality of second gears are arranged on the plurality of first motors in one-to-one correspondence; and the plurality of second gears are respectively engaged with the first gear for transmission.

5. The torque-drive active control system of claim 1, wherein the rotating assembly comprises a rotating component, a second motor, a second rotating shaft and a rotary plate; the rotating component is arranged on the end of the first rotating shaft away from the to-be-controlled object; the second motor is arranged a side of the rotating component away from the first rotating shaft, and the second rotating shaft is rotatably arranged on the side of the rotating component away from the first rotating shaft; the rotary plate is arranged on an end of the second rotating shaft away from the rotating component; the second motor is drivably connected with the rotary plate; and the controller is configured to control the second motor to drive the rotary plate to rotate according to the processing result.

6. The torque-drive active control system of claim 5, wherein the rotating component comprises a rotating base and a rotating arm arranged on the rotating base; the rotating base is arranged on the end of the first rotating shaft away from the to-be-controlled object; the second motor is arranged on a side of the rotating arm away from the first rotating shaft; and the second rotating shaft is rotatably arranged on a side of the rotating base away from the first rotating shaft.

7. The torque-drive active control system of claim 6, wherein a plurality of rotating arms and a plurality of second motors are provided; the plurality of rotating arms are arranged spaced apart on the rotating base; the plurality of second motors are arranged on sides of the plurality of rotating arms away from the first rotating shaft in one-to-one correspondence; and each of the plurality of second motors is drivably connected with the rotary plate.

8. The torque-drive active control system of claim 1, wherein a plurality of connecting arms are provided; the plurality of connecting arms are arranged spaced apart on the mounting base; and an end of each of the plurality of connecting arms away from the mounting base is connected with the inner wall of the to-be-controlled object.
